(19) United States
(12) Patent Application Publication
(10) Pub. No.: US 2006/0075239 A1
(43) Pub. Date: Apr. 6, 2006

(54) Embedding multiple watermarks

(75) Inventors: Alphons Antonius Maria Lambertus Bruekers, Eindhoven (NL); Jaap Andre Haitsma, Eindhoven (NL); Minne Van Der Veen, Eindhoven (NL); Antonius Adrianus Cornelis Maria Kalker, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/542,891

(22) PCT Filed: Dec. 16, 2003
(86) PCT No.: PCT/IB03/06180

§ 371 Date: Jul. 20, 2005

(30) Foreign Application Priority Data
Jan. 23, 2003 (EP) 03100132.4

(51) Int. Cl. H04L 9/00

(52) U.S. Cl. 713/176

(57) ABSTRACT

In order to enable a data signal, such as an audio or video signal, to be marked with multiple watermarks a set of different codes or keys is used within a given application field. The set of codes/keys is known to a watermark embedder (20) and a watermark detector (22). In each watermark embedding step, whether it is a first embedding step or a subsequent embedding step, a different key is used. The embedder (22) includes a data extractor (24) for determining which key or keys has or have been used previously. A data generator (26) then selects a new key from the set of known keys.

This invention relates to a method of embedding multiple watermarks into data signals, particularly, but not limited to, a method of embedding multiple watermarks into audio and/or video signals.

Embedding data into audio or video signals by means of watermarking technology is well known and is described in, for instance, Van der Veen M., Bruekers F., Haitsma J., Kalker T., Lemma A. and Oomen W., 2001, Robust, multi-functional and high-quality audio watermarking technology: Convention paper, presented at the 110^{th} Convention of the AES, May 12-15, Amsterdam, The Netherlands, and Swanson M., Twefik A. and Boney L., 1998, Robust audio watermarking using perceptual masking: Signal Processing, 66, pp. 337-355, both of which are incorporated herein by reference.

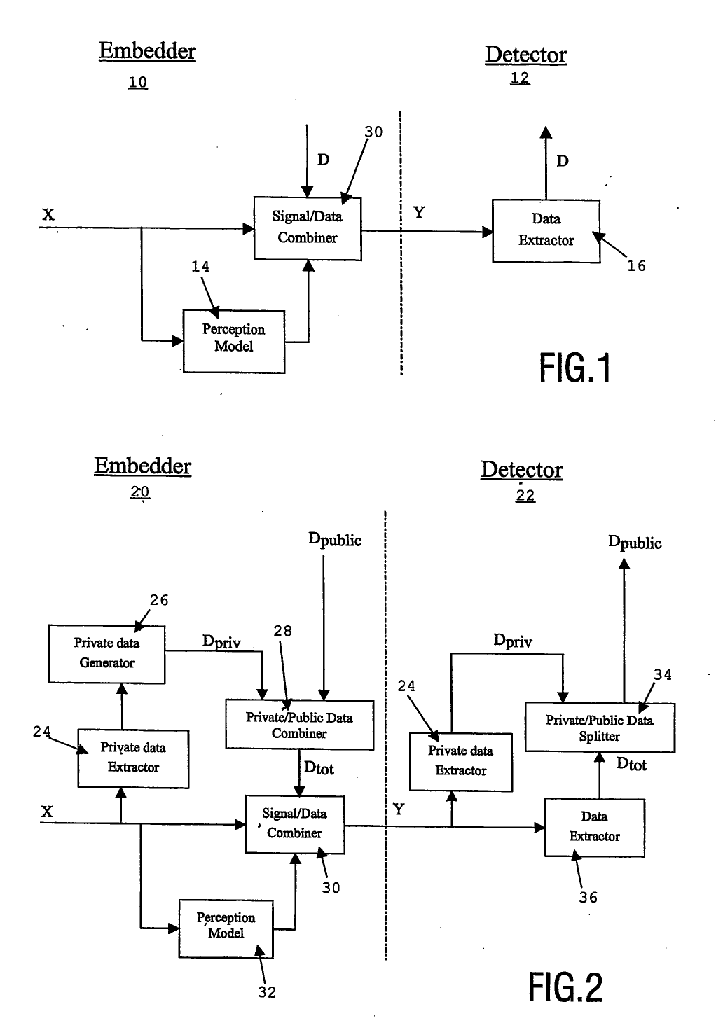

In FIG. 1 there is shown a general block diagram for both a watermark embedder 10 and a watermark detector 12. The basic functionality of a watermark embedder 10 is the combining of a signal X with a set of user data D to produce an output signal Y. The signal X is the audio or video signal of interest, whereas the user data D is the watermark. Often, auditory or visual perception models 14 are deployed to control the quality of the output signal Y. In the watermark detector 12, the set of user data D is extracted from the watermarked output signal Y with a data extractor 16.

In some implementations of the approach described above problems may be introduced when multi-marking signal Y. e.g. embedding multiple watermarks, i.e. stacking different watermark signals. If for example signal Y, with a data set D₀ is watermarked again, or multi-marked, with data set D₁, the detector 12 will not be able to retrieve either data set D₀ or data set D₁, or both Besides these three options, it may also be more difficult to retrieve both data sets Both watermarks D₀ and D₁ are said to have destructive interference.

It is an object of the present invention to address the above mentioned disadvantage.

According to a first aspect of the present invention a method of embedding a watermark in a signal comprises:

checking a signal to be watermarked for a two-part watermark, a first part of which comprises a first identifier portion and a second part of which comprises a first information portion;

on finding said two-part watermark, the method includes identifying the first identifier portion and selecting a different identifier portion from a set of identifier portions and combining the different identifier portion with an information portion of the watermark to be embedded; and

on finding no two-part watermark, the method includes selecting an identifier portion from the set of identifier portions and combining the identifier portion with the information portion of the watermark to be embedded;

the identifier and information portions are then combined to produce the watermark for embedding.

The information portion preferably includes a payload of the watermark, preferably having the information or instructional content of the watermark.

Preferably, the identifier portions are substantially orthogonal to one another, preferably there is substantially no destructive interference between identifier portions. Preferably, the identifier portions in the set of identifier portions are chosen to be orthogonal/non-interfering with each other.

The identifier portions may be carriers, in which case the information portions are used to modulate the identifier portions.

The method may include checking for more than one two-part watermark. Preferably, the method is operable to embed multiple two-part watermarks. Preferably, the method includes the selection of an identifier portion different to all identifier portion(s) of (an)other detected two-part watermark(s).

Preferably, the set of identifier portions is in the form of a list. Preferably, the first unused identifier portion in the list is used for combination with the information portion of the watermark to be embedded.

The watermark(s) may include a label portion, which label portion may indicate the next identifier portion to be used.

The identifier portions may be derived from a seed that indicates what the identifier portions are.

The watermark may be embedded using perception model techniques.

The method may include embedding multiple two-part watermarks.

According to a second aspect of the invention, a method of detecting a watermark in a signal comprises:

checking a signal of interest for at least one two-part watermark, a first part of each watermark comprising an identifier portion and at least one corresponding information portion;

checking the or each identifier portion for correspondence with an identifier portion in a set of known identifier portions;

extracting each identifier portion corresponding to a member of the set to give its corresponding information portion, to thereby allow use of the information portion.

The method preferably includes the detection of one or more two-part watermarks.

According to a third aspect, a watermark embedder operable to perform the method of the first aspect.

The watermark embedder may incorporate an identifier portion extractor, operable to extract the identifier portion from a two-part watermark.

The watermark embedder is preferably operable to supply an extracted identifier portion to an identifier portion generator, the latter preferably being operable to generate an identifier portion substantially different to the extracted identifier portion. The identifier portion generator preferably selects an identifier from a predetermined list.

The watermark embedder preferably includes a data combiner, operable to combine the identifier portion of a two-part watermark with an information portion thereof.

The watermark embedder preferably includes a signal/data combiner operable to combine the two-part watermark with a data signal to be watermarked.

According to a fourth aspect a watermark detector operable to perform the method of the second aspect.

The watermark detector preferably includes an identifier portion extractor as described in the third aspect.

The watermark detector preferably includes an identifier portion/information portion splitter operable to separate an extracted identifier portion from its corresponding information portion.

The watermark detector preferably includes a data extractor, which is preferably operable to extract a two-part watermark from a received signal.

According to a fifth aspect a recordable medium carrying data having a watermark embedded according to the first aspect.

All of the features described herein can be combined with any of the above aspects, in any combination.

For a better understanding of the invention and to show how the same may be brought into effect, specific embodiments will now be described, by way of example, with reference to the accompanying drawings, in which:

FIG. 1 is a schematic flow diagram of a prior art watermark embedder and detector structure;

FIG. 2 is a schematic flow diagram of an embedder and detector structure for embedding and detecting multiple watermarks;

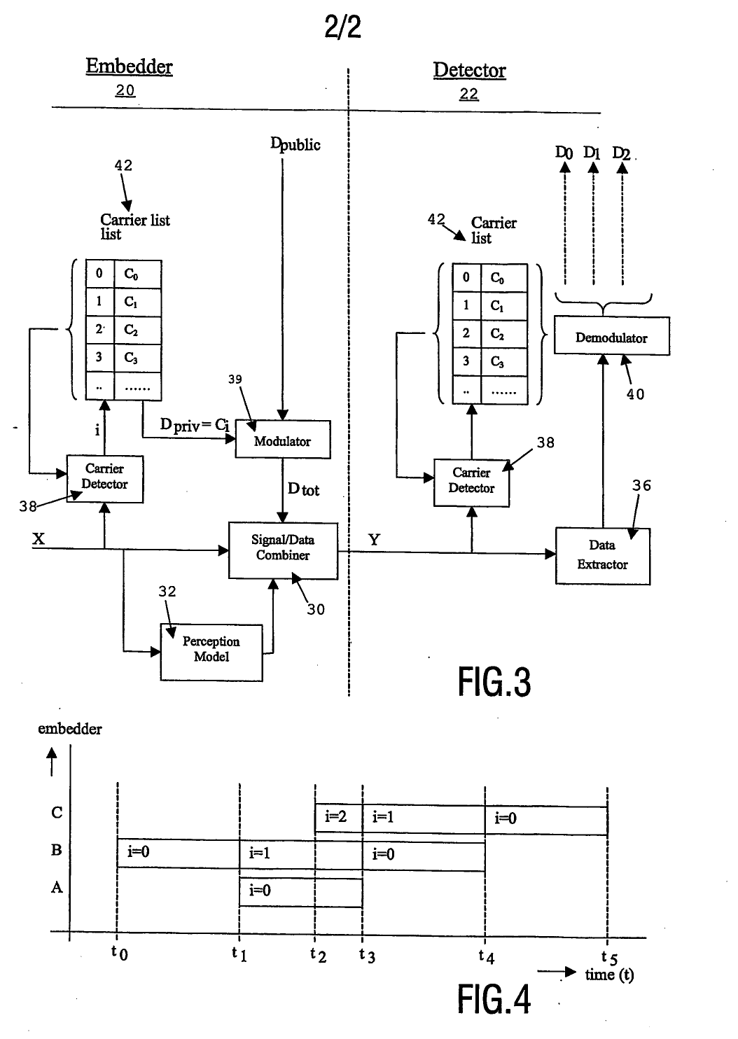

FIG. 3 is a schematic diagram of a watermark embedder and detector structure for a structure that makes use of multiple carriers for data to be watermarked; and

FIG. 4 is a schematic representation of multiple watermarks embedded in the same signal and variation of the watermarks over time.

In order to enable a data signal, such as an audio or video signal, to be marked with multiple watermarks a set of different codes or keys is used within a given application field. The set of codes/keys is known to a watermark embedder 20 and a watermark detector 22. In each watermark embedding step, whether it is a first embedding step or a subsequent embedding step, a different key is used. The embedder 22 includes a data extractor 24 for determining which key or keys has or have been used previously. A data generator 26 then selects a new key from the set of known keys.

As shown in FIG. 2 a signal X is to be combined with a total data set Dₜₒₜ. The total data set Dₜₒₜ that will be combined with the input signal X consists of two parts: a public data set D_{public} and private data set Dₚᵣᵢᵥ. The public data set is the net data that needs to be embedded into the input signal X. The private data set is generated by the watermark embedder 20 in such a way that the total Dₜₒₜ is orthogonal to a total data set which has been produced using a different private data set Dₚᵣᵢᵥ, such as a different carrier. The carriers may be orthogonal noise sequences. Given that total data sets Dₜₒₜ with different private data sets, Dₚᵣᵢᵥ have less or no destructive interference, the individual total data sets Dₜₒₜ (or watermarks) are much more easily detectable, especially when multi-marking is present.

It should be borne in mind that the number of watermarks that can be added to a signal is in practice limited, because eventually, given a sufficiently great number of watermarks, severe degradation of the signal X being watermarked will result. Consequently, the number of different watermarks to be included is limited, which number is the same or less than the number of private data sets Dₚᵣᵢᵥ provided.

For a particular watermarking application a sufficient number of different private data sets Dₚᵣᵢᵥ is defined and is stored in the embedder 20 and the detector 22. Prior to combining the total data set Dₜₒₜ with the input signal X, the watermark embedder 20 evaluates the input signal X to determine what private data sets Dₚᵣᵢᵥ have already been used. The input signal X is analysed with a private data extractor 24. On the basis of the results of the examination, a new private data set Dₚᵣᵢᵥ is generated from the set stored in the private data generator 26 and is combined with the public data set D_{public} in a private/public data combiner 28. Thus, the signal Dₜₒₜ is formed and is combined with the signal X in a signal/data combiner 30.

A perception model 32 may optionally be used in conjunction with the input signal X whilst the combination with Dₜₒₜ is being performed. The use of a perception model 32 is the same as is well known in the prior art.

In the detector 22, a data splitter 34 generates a public output data section D_{public} for every private data set Dₚᵣᵢᵥ in an incoming signal Y. The incoming signal Y is processed using a data extractor 36 which extracts the signal Dₜₒₜ. Also, a private data extractor 24, the same as that in the embedder 20, extracts a private data set Dₚᵣᵢᵥ, which is input into the private/public data splitter 34 to enable a signal of the public data set D_{public} to be output. Consequently, the detector 22 produces a series of public output data sets D_{public}, assuming that a number of private data sets are detected. For this reason a mechanism is required to indicate the origin or destination of the public data sets D_{public}. One way of solving this is to allocate address fields in the public data set D_{public}. Some cryptographic and/or error detection mechanism may be applied on the public data set, but this is optional. Any malicious user of a watermark detector should not be able to trace the address fields. Therefore, payload, or address fields may be encrypted. Moreover payload capacity may be used to transmit EEC bits, which will enhance detection performance.

A particular embodiment of the system more generally described above in relation to FIG. 2 is shown in FIG. 3. The watermarking algorithm described in Robust, Multi-functional and High Quality Audio Watermarking Technology (above) can be used as a basis for the following embodiment. The content of that document is incorporated herein by reference. The following watermarking algorithm may be used:
Wᵢ(k)=Wₛ(k)Xᵢ(k),
where ᵢ indicates the frame number, Xᵢ(k) the spectral representation of the frame signal Xᵢ(n) and Wᵢ(k), the resulting frequency domain watermark.

This equation is used on an audio signal that is segmented into frames and transformed to the frequency domain. The magnitudes of the Fourier coefficients are slightly modified by utilising a shifted watermark Wₛ(k).

In this algorithm the private data set Dₚᵣᵢᵥ is represented by a carrier Cᵢ that will be modulated (by modulator 39) by the public data set D_{public}. The signal/data combiner 30 shown in FIG. 2 is also present in FIG. 3. The signal/data combiner 30 consists of the Fourier transform, a multiplication, and an inverse Fourier transform. The perception model 32 can be a transient detector that disables embedding of the watermark Dₜₒₜ in the vicinity of a detected transient. In the FIG. 3 embodiment the private data extractor 24 of FIG. 2 is replaced by a carrier detector 38. The carrier detector 38 in both the embedder 20 and the detector 22 use correlation techniques to determine the presence of a particular carrier (which in this instance is the example of the private data set) without interpreting the embedded data. A demodulator 40 determines for what cyclic shift correlation is maximal by deriving correlation for different cyclic shifts. Based on this the payload is extracted.

In FIG. 4 it is shown how multiple private data sets or carriers are used to obtain non-destructive interfering watermarks. A plurality of embedders 20 indicated at A to C in FIG. 4 are used. Embedder A starts embedding its data a t=t₁ and proceeds until t=t₃, as shown by the x-axis of the graph shown in FIG. 4. Assuming that the original signal x is watermark free, the carrier detector 38 (or private data extractor 24) will not detect any carrier (private data set) and proposes to use the first carrier (private data set) available in the list 42 shown in FIG. 3. In this case Dₚᵣᵢᵥ=C₀ for i=0.

A second watermark embedder B starts embedding its data at t=t₀ and proceeds until t=t₄. The carrier detector 38 (private data extractor 24) will not detect any carrier (private data set) in the period from t=t₀ through to t=t₁ so it proposes to use the first carrier (private data set) available in the carrier list 42; Dₚᵣᵢᵥ=C₀ for i=0. From t=t₁ through t=t₃ carrier (private data set) C₀ will be detected as it is used by embedder A earlier. Therefore, it is proposed to use the second carrier (private data set) available in the carrier list 42; Dₚᵣᵢᵥ=C₁ for i=1. In the interval from t=t₃ through to t=t₄ no other carrier (private data set) will be detected and therefore embedder B will continue by using carrier (private data set) C₀. The next watermark embedder C starts embedding its public data at t=t₂ and proceeds until t=t₅. With the same strategy as embedder B, the carrier's (private data set) C₂, C₁ and C₀ are selected for the three time intervals, as shown in FIG. 4.

In the examples of FIGS. 3 and 4, the carrier (private data set) lists 42 are ordered in a way to allow determination of which private data sector was embedded first, second, third or later. The private data sector embedded with carrier Cᵢ₊₁ is embedded later than the private data set embedded with the carrier Cᵢ. In the embedder 20 it is proposed to use the next carrier from the carrier list 42. In principal, it would be sufficient to select an unused carrier from the list. Using an audit carrier list 42 may also be beneficial for the algorithmic complexity of the carrier detector 38.

An optional way in which to reduce the algorithmic complexity of the private data set detector 24 or carrier detector 38 is as follows. Next to the total data set Dₜₒₜ additional information concerning the use of private data sets may be embedded in the signal. For example, it is possible to look ahead with the private data set extractor 24 in the embedder 20 and if some change in private data set usage is foreseen, this may be signalled explicitly in the watermark. Consequently, subsequent private data set extractors 24, both embedder 20 and detector 22 can use this signal instead of or as a support in performing private data set extraction operations. In relation to the above, it is deemed to be advantageous to spend a few bits of information content in the payload to announce that the key is about to change, because this better enables the embedder 20 of detector 22 to account for those changes.

In FIG. 3, the carrier detector 38 is used to extract the particular carrier C₀ to C₃ that has been embedded by the embedder 20. The demodulator is then used to remove the carrier from the Dₜₒₜ to reveal the public data set D₀ to D₃. In this way, any one of the different public watermarks D₀ to D₃ is extracted from the signal Y without any interference from any of the other watermarks and without any negative effect on the original signal X that has received the watermark A carrier is selected from the list, and based on the carrier, either, D0, D1 or D3 are extracted.

The method may include the private data sets being generated from a seed for private data sets

In the method of inserting and detecting multiple watermarks disclosed above, significant advantages are derived because of the lack of interference, or minimised interference, between multiple watermarks. This provides advantages in that the audio or video signal to be watermarked can be the result of an editing process, which may comprise a composition of multiple original works, some of which already have an embedded watermark. In this case, the selected private data set may change in time, as described above.

The invention can be summarized as follows. In order to enable a data signal, such as an audio or video signal, to be marked with multiple watermarks a set of different codes or keys is used within a given application field. The set of codes/keys is known to a watermark embedder (20) and a watermark detector (22). In each watermark embedding step, whether it is a first embedding step or a subsequent embedding step, a different key is used. The embedder (22) includes a data extractor (24) for determining which key or keys has or have been used previously. A data generator (26) then selects a new key from the set of known keys.

1. A method of embedding a watermark in a signal comprises:
checking a signal to be watermarked for a two-part watermark, a first part of which comprises a first identifier portion and a second part of which comprises a first information portion;
on finding said two-part watermark, the method includes identifying the first identifier portion and selecting a different identifier portion from a set of identifier portions and combining the different identifier portion with an information portion of the watermark to be embedded; and
on finding no two-part watermark, the method includes selecting an identifier portion from the set of identifier portions and combining the identifier portion with the information portion of the watermark to be embedded;
the identifier and information portions are then combined to produce the watermark for embedding.

2. A method as claimed in claim 1, in which the information portion includes a payload of the watermark, having information or instructional content of the watermark.

3. A method as claimed in either claim 1, in which the identifier portions are substantially orthogonal to one another.

4. A method as claimed in claim 1, in which the identifier portions in the set of identifier portions are chosen to be orthogonal/non-interfering with each other.

5. A method as claimed in claim 1, which includes checking for more than one two-part watermark.

6. A method as claimed in claim 1, which is operable to embed multiple two-part watermarks.

7. A method as claimed in claim 1, in which the set of identifier portions is in the form of a list, the first unused identifier portion in the list being used for combination with the information portion of the watermark to be embedded.

8. A method as claimed in claim 7, in which the watermark includes a label portion, which indicates the next identifier portion that should be used.

9. A method as claimed in claim 1, in which the identifier portions are carriers, and the information portions are used to modulate the identifier portions.

10. A method of detecting a watermark in a signal comprises:
checking a signal of interest for at least one two-part watermark, a first part of each watermark comprising an identifier portion and at least one corresponding information portion;
checking the or each identifier portion for correspondence with an identifier portion in a set of known identifier portions;
extracting each identifier portion corresponding to a member of the set to give its corresponding information portion, to thereby allow use of the information portion.

11. A watermark embedder operable to perform the method of claim 1.

12. A watermark detector operable to perform the method of claim 10.

13. A recordable medium carrying data having a watermark embedded accorded to the method of claim 1.
